(19) United States
(12) Patent Application Publication
(10) Pub. No.: US 2026/0117020 A1
(43) Pub. Date: Apr. 30, 2026

(54) Biodegradable PVC Replacement

(71) Applicant: Danimer IPCo, LLC, Bainbridge, GA (US)

(72) Inventors: Karson Durie, Athens, GA (US); Michael N. Mang, Bainbridge, GA (US); Eric McClanahan, Athens, GA (US); Mangaldeep Kundu, Athens, GA (US); Abdala Bashir, Tallahassee, FL (US)

(21) Appl. No.: 19/476,571

(22) PCT Filed: Apr. 18, 2024
(86) PCT No.: PCT/US2024/025221

§ 371 Date: Oct. 17, 2025

Related U.S. Application Data
(60) Provisional application No. 63/460,499, filed on Apr. 19, 2023.
(60) Provisional application No. 63/611,928, filed on Dec. 19, 2023.

(51) Int. Cl. C08G 63/06; A01K 85/00; C08K 5/103; C08K 5/11; C09D 7/63; C09D 11/104

(52) U.S. Cl. CPC C08G 63/06; A01K 85/00; C08K 5/103; C08K 5/11; C09D 7/63; C09D 11/104

(57) ABSTRACT

The present disclosure provides a plastisol composition which includes from about 1 to about 49 weight percent of at least one polyhydroxyalkanoate. The plastisol composition also includes from about 51 to about 99 weight percent of at least one plasticizer selected from the group consisting of epoxidized vegetable oils, citric acid esters, triglycerides, and mixtures thereof. A screen-printing ink, which includes the plastisol, is also disclosed.

### FIELD

This disclosure relates to biodegradable polymeric compositions. More particularly, this disclosure relates to biodegradable polymeric compositions comprising poly(hydroxyalkanoates), which may be used to form plastisols and flexible molded articles.

### BACKGROUND

Polyvinylchloride (PVC) is widely used in the plastics industry due to its unique physical and converting properties. In particular, PVC is used to produce highly flexible polymer compositions such as plastisols. Typically, such flexible PVCs are highly plasticized with phthalate-based plasticizers, which disrupt chain interactions, lowering the overall crystallinity and increasing flexibility. Different levels of plasticizers are used for various applications, with the levels specifying the degree of softness and flexibility.

However, the use of PVC also includes multiple drawbacks from a health and environmental standpoint. PVC is known to release toxic by-products into the environment, particularly vinyl chloride. Vinyl chloride has been determined to be a carcinogen. Moreover, the end-of-life disposal of PVC-based products is also problematic, as PVC exhibits little to no biodegradation when buried in landfills or leaked into marine environments.

Further still, the phthalate-based plasticizers typically used with PVC are also known to be endocrine disruptors.

Thus, it would be desirable to provide alternative polymer compositions which may be used in place of plasticized PVC compositions for the production of plastisols and other flexible articles. Preferably, these compositions would be biodegradable and/or non-toxic. In particular, the plastisol compositions would be free of PVC.

It would also be desirable to provide inks, such as screen-printing inks, which incorporate the aforementioned plastisol compositions. In addition, it would be desirable to provide molded articles such as fishing lures, which are formed from the plastisol composition.

Furthermore, it would be desirable to provide a process for forming molded articles from the aforementioned plastisol composition.

### SUMMARY

The above and other needs are met by a polyhydroxyalkanoate (PHA)-based plastisol, according to the present disclosure.

In a first aspect, the present disclosure provides a composition for a plastisol. According to one embodiment, the plastisol composition includes from about 1 to about 49 weight percent of at least one polyhydroxyalkanoate. The plastisol composition also includes from about 51 to about 99 weight percent of at least one plasticizer selected from the group consisting of epoxidized vegetable oils, citric acid esters, triglycerides, and mixtures thereof.

According to certain embodiments, the composition preferably includes from about 1 to about 40 weight percent of at least one polyhydroxyalkanoate; and from about 60 to about 99 weight percent of at least one plasticizer selected from the group consisting of epoxidized vegetable oils, citric acid esters, triglycerides, and mixtures thereof.

In certain embodiments, the composition more preferably includes from about 1 to about 10 weight percent of the at least one polyhydroxyalkanoate.

In some instances, a single form of plasticizer may be used in the composition. For instance, the composition may include only a citric acid ester, such as triethyl citrate, as a plasticizer. Alternatively, the composition may include only a triglyceride, such as triacetin, as a plasticizer.

In other embodiments, the composition may include a combination of plasticizers. According to some embodiments, the composition preferably includes from about 60 to about 80 weight percent of at least one citric acid ester. More preferably, the composition also includes from about 10 to about 35 weight percent of at least one triglyceride.

In certain embodiments, the composition more preferably includes from about 60 to about 80 weight percent of triethyl citrate. Still, more preferably, the composition also includes from about 10 to about 35 weight percent of triacetin.

In some instances, the composition preferably includes at least one epoxidized vegetable oil selected from the group consisting of epoxidized soybean oil, epoxidized linseed oil, epoxidized castor oil, epoxidized coconut oil, epoxidized soybean oil, and mixtures thereof. More preferably, the composition includes epoxidized soybean oil.

In accordance with certain embodiments, the composition preferably also includes from about 0.01 to about 0.5 weight percent of at least crosslinking agent selected from the group consisting of organic peroxides, epoxides, carbodiimides, oxazolines, and mixtures thereof.

In some embodiments, the composition also preferably includes from about 0.01 to about 1 weight percent of at least one nucleating agent selected from the group consisting of pentaerythritol, dipentaerythritol, boron nitride, and mixtures thereof.

According to certain embodiments, the composition also preferably includes from about 0.1 to about 20 weight percent of at least one biopolymer selected from the group consisting of polylactic acid, polybutylene succinate, polybutylene succinate adipate, polybutylene adipate terephthalate, phenylbenzimidazole sulfonic acid, and mixtures thereof.

In some instances, the at least one polyhydroxyalkanoate preferably includes a polyhydroxyalkanoate copolymer, which includes from about 0.5 to about 25 mole percent monomer repeat units selected from the group consisting of 4-hydroxybutyrate, 3-hydroxyhexanoate, 3-hydroxyoctanoate, 3-hydroxydecanoate, and mixtures thereof.

In some embodiments, the at least one polyhydroxyalkanoate preferably includes one or more poly-3-hydroxybutyrate-co-3-hydroxyhexanoate (P3HB-co-P3HHx) copolymers, wherein each P3HB-co-P3HHx copolymer comprises from about 2 to about 15 mole percent monomer repeat units of 3-hydroxyhexanoate.

According to certain embodiments, the composition is preferably free of phthalates.

In certain embodiments, the composition may also include from about 0.05 weight percent to about 1.0 weight percent of at least one nucleating agent selected from the group consisting of pentaerythritol, dipentaerythritol, boron nitride, poly(hydroxybutyrate), inositol, clays, sorbitol, and mixtures thereof. More preferably, the composition may include from about 0.10 weight percent to about 0.20 weight percent of the at least one nucleating agent.

In some embodiments, the composition may also include from about 0.5 weight percent to about 20 weight percent of at least one filler selected from the group consisting of aragonite, clays, calcium carbonate, cellulose, nano-cellulose, talc, kaolinite, montmorillonite, bentonite, silica, chitin, starches, diatomaceous earth, titanium dioxide, nano clay, mica, and mixtures thereof. More preferably, the composition may include from about 1.0 weight percent to about 5.0 weight percent of the at least one filler.

In accordance with certain embodiments, the composition may also include from about 0.01 weight percent to about 1.0 weight percent of at least one rheology modifier selected from the group consisting of organic peroxides, carbodiimides, oxazolines, epoxides, and mixtures thereof. More preferably, the composition may include from about 0.1 weight percent to about 0.5 weight percent of the at least one rheology modifier.

According to some embodiments, the composition may also include from about 0.5 weight percent to about 20 weight percent of natural or synthetic fibers. More preferably, the composition may include from about 1.0 weight percent to about 5.0 weight percent of the fibers.

In a second aspect, the present disclosure also provides an ink suitable for screen printing. According to one embodiment, the ink includes at least one pigment and a plastisol composition, such as the plastisol compositions described above. Thus, the plastisol composition, in turn, includes from about 1 to about 49 weight percent of at least one polyhydroxyalkanoate and from about 51 to about 99 weight percent of at least one plasticizer selected from the group consisting of epoxidized vegetable oils, citric acid esters, triglycerides, and mixtures thereof.

In certain embodiments, the pigment is preferably an inorganic pigment. However, in other embodiments, the pigment is preferably an organic pigment.

According to certain embodiments, the ink preferably also includes at least one additive selected from the group consisting of fillers, rheology modifiers, stabilizing agents, and mixtures thereof.

In some instances, the plastisol composition is preferably present in the ink in an amount from about 70 to about 99 weight percent of the ink.

In certain embodiments, the plastisol composition of the ink more preferably includes from about 1 to about 10 weight percent of the at least one polyhydroxyalkanoate.

According to some embodiments, the plastisol composition of the ink preferably includes from about 60 to about 80 weight percent of at least one citric acid ester. More preferably, the plastisol composition also includes from about 10 to about 35 weight percent of at least one triglyceride.

In certain embodiments, the plastisol composition of the ink more preferably includes from about 60 to about 80 weight percent of triethyl citrate. Still, more preferably, the plastisol composition also includes from about 10 to about 35 weight percent of triacetin.

In a further aspect, the present disclosure also provides a coated article. In accordance with one embodiment, the coating article includes at least a first surface and a coating applied over at least a portion of the first surface. The coating is applied by dipping the first surface in a plastisol composition. This plastisol includes from about 1 to about 49 weight percent of at least one polyhydroxyalkanoate and from about 51 to about 99 weight percent of at least one plasticizer selected from the group consisting of epoxidized vegetable oils, citric acid esters, triglycerides, and mixtures thereof. More preferably, the plastisol includes from about 1 to about 40 weight percent of the at least one polyhydroxyalkanoate and from about 60 to about 99 weight percent of the at least one plasticizer.

In certain embodiments, the article is preferably a hand tool, and the coating forms a hand grip.

In another aspect, the present disclosure provides a fishing lure. According to one embodiment, the fishing lure includes a soft plastic fishing bait molded from the plastisol composition described above, i.e., a plastisol composition which includes from about 1 to about 49 weight percent of at least one polyhydroxyalkanoate and from about 51 to about 99 weight percent of at least one plasticizer selected from the group consisting of epoxidized vegetable oils, citric acid esters, triglycerides, and mixtures thereof.

The fishing lure also includes at least one hook attached to the soft plastic fishing bait and at least one weight attached to the soft plastic fishing bait.

In some instances, the composition of the fishing bait may also include about 0.1 weight percent to about 5.0 weight percent of at least one attractant selected from the group consisting of glitter flakes, liquid colorant, powdered pigments, fish scent attractants, and mixtures thereof. More preferably, the composition may include from about 0.5 weight percent to about 2.0 weight percent of the at least one attractant.

In yet another aspect, the present disclosure provides a process for making a molded article. In accordance with one embodiment, the process includes a step of mixing at least one polyhydroxyalkanoate and at least one plasticizer selected from the group consisting of epoxidized vegetable oils, citric acid esters, triglycerides, and mixtures thereof to form a slurry comprising from about 1 to about 49 weight percent of the at least one polyhydroxyalkanoate and from about 51 to about 99 weight percent of the at least one plasticizer. The process also includes a step of heating the slurry to a temperature of at least about 85° C. to form a molten mixture. This molten mixture is then injected into a mold. The mixture is then cooled within the mold to form a solidified molded article. Finally, the molded article is removed from the mold.

### DETAILED DESCRIPTION

The present disclosure provides a polyhydroxyalkanoate (PHA)-based plastisol composition, which is preferably biodegradable and free of phthalate-based compounds. The present disclosure also provides an ink for screen printing, which comprises the plastisol composition, and a coated article, wherein the coating comprises the plastisol composition.

The plastisol composition comprises at least one polyhydroxyalkanoate and also comprises at least one plasticizer selected from the group consisting of epoxidized vegetable oils, citric acid esters, triglycerides, and mixtures thereof.

The amount of the at least one polyhydroxyalkanoate is generally from about 1 to about 49 weight percent of the composition and preferably from about 1 to about 40 weight percent of the composition. More preferably, the at least one polyhydroxyalkanoate makes up from about 1 to about 10 weight percent of the composition.

The at least one polyhydroxyalkanoate may be a homopolymer, a copolymer, or a terpolymer. In some instances, the at least one polyhydroxyalkanoate may comprise a mixture of polyhydroxyalkanoate homopolymer, polyhydroxyalkanoate copolymer, and/or polyhydroxyalkanoate terpolymer.

In certain embodiments, the at least one polyhydroxyalkanoate preferably comprises a polyhydroxyalkanoate copolymer. For example, the at least one polyhydroxyalkanoate may comprise a polyhydroxyalkanoate copolymer, which includes from about 0.5 to about 25 mole percent monomer repeat units selected from the group consisting of 4-hydroxybutyrate, 3-hydroxyhexanoate, 3-hydroxyoctanoate, 3-hydroxydecanoate, and mixtures thereof. More preferably, the at least one polyhydroxyalkanoate comprises one or more poly-3-hydroxybutyrate-co-3-hydroxyhexanoate (P3HB-co-P3HHx) copolymers, and even more preferably, each of these copolymers includes from about 2 to about 15 mole percent monomer repeat units of 3-hydroxyhexanoate.

The plastisol composition also includes from about 51 to about 99 weight percent of at least one plasticizer selected from the group consisting of epoxidized vegetable oils, citric acid esters, triglycerides, and mixtures thereof. Preferably, the plastisol composition comprises from about 60 to about 99 weight percent of the at least one plasticizer.

Suitable epoxidized vegetable oils which may be used as a plasticizer in the composition include epoxidized soybean oil, epoxidized linseed oil, epoxidized castor oil, epoxidized coconut oil, epoxidized soybean oil, and mixtures thereof. In some embodiments of the present disclosure, epoxidized vegetable oil is a particularly preferred epoxidized soybean oil.

Examples of suitable citric acid esters which may be used as a plasticizer in the composition include triethyl citrate, tributyl citrate, acetyl triethyl citrate, and acetyl tributyl citrate. A preferred citric acid ester is triethyl citrate.

In some embodiments, a preferred triglyceride plasticizer may be triacetin.

In general, the amount of plasticizer in the composition is from about 51 to about 99 weight percent of the composition, and more preferably from about 60 to about 99 weight percent of the composition.

In some instances, the composition may comprise only a single plasticizer in an amount from about 60 to about 99 weight percent. For instance, the composition may include only a citric acid ester such as triethyl citrate or only a triglyceride such as triacetin.

In other embodiments, the composition may comprise a combination of plasticizers. For instance, in some embodiments, the plastisol composition may comprise from about 60 to about 80 weight percent of at least one citric acid ester. This composition may also comprise from about 10 to about 35 weight percent of at least one triglyceride.

As noted above, a preferred citric acid ester may be triethyl citrate, and a preferred triglyceride may be triacetin. Thus, in certain embodiments, the plastisol composition may comprise a combination of these two plasticizers. For instance, the plastisol composition may comprise from about 60 to about 80 weight percent of triethyl citrate and from about 10 to about 35 weight percent of triacetin.

In addition to the polyhydroxyalkanoate and plasticizer, the plastisol composition may also include various other additives.

In certain embodiments, the composition may also include from about 0.05 weight percent to about 1.0 weight percent of at least one nucleating agent selected from the group consisting of pentaerythritol, dipentaerythritol, boron nitride, poly(hydroxybutyrate), inositol, clays, sorbitol, and mixtures thereof. More preferably, the composition may include from about 0.10 weight percent to about 0.20 weight percent of the at least one nucleating agent.

In some embodiments, the composition may also include from about 0.5 weight percent to about 20 weight percent of at least one filler selected from the group consisting of aragonite, clays, calcium carbonate, cellulose, nano-cellulose, talc, kaolinite, montmorillonite, bentonite, silica, chitin, starches, diatomaceous earth, titanium dioxide, nano clay, mica, and mixtures thereof. More preferably, the composition may include from about 1.0 weight percent to about 5.0 weight percent of the at least one filler.

In accordance with certain embodiments, the composition may also include from about 0.01 weight percent to about 1.0 weight percent of at least one rheology modifier selected from the group consisting of organic peroxides, carbodiimides, oxazolines, epoxides, and mixtures thereof. More preferably, the composition may include from about 0.1 weight percent to about 0.5 weight percent of the at least one rheology modifier.

According to some embodiments, the composition may also include from about 0.5 weight percent to about 20 weight percent of natural or synthetic fibers. More preferably, the composition may include from about 1.0 weight percent to about 5.0 weight percent of the fibers.

According to certain embodiments, the composition also preferably comprises from about 0.1 to about 20 weight percent of at least one biopolymer selected from the group consisting of polylactic acid, polybutylene succinate, polybutylene succinate adipate, polybutylene adipate terephthalate, phenylbenzimidazole sulfonic acid, and mixtures thereof.

In general, the plastisol composition, according to the present disclosure, is biodegradable, as determined by ASTM D6691. More preferably, each of the components of the plastisol composition is individually biodegradable, as determined by ASTM D6691.

It is also generally preferred that the composition include little or no phthalates. In some embodiments, the composition includes less than 1 weight percent of phthalate-based compounds. In more preferred embodiments, the composition is free of phthalate-based compounds.

Advantageously, the plastisol composition, according to the present disclosure, is highly flexible and moldable. Accordingly, the plastisol composition may be used as a replacement for polyvinyl chloride (PVC)-based plastisols in many applications. In addition to eliminating the need for PVC itself, the phthalate-based plasticizers typically used with PVCs are also avoided. And, as just noted, the plastisol composition, according to the present disclosure, is biodegradable.

The aforementioned plastisol composition may be prepared by a process which includes a first step of mixing at least one polyhydroxyalkanoate as discussed above and at least one plasticizer selected from the group consisting of epoxidized vegetable oils, citric acid esters, triglycerides, and mixtures, as also discussed above to form a slurry. This slurry is generally made of from about 1 to about 49 weight percent of the at least one polyhydroxyalkanoate and from about 51 to about 99 weight percent of the at least one plasticizer.

Any other optional additives may also be mixed into the slurry, including crosslinking agents, nucleating agents, additional biopolymers, mold release agents, and so forth.

This slurry is heated to a temperature of at least about 85° C. (preferably from about 105° C. to about 125° C.) to form a molten plastisol composition. This plastisol composition may then be molded to form various articles, such as flexible fishing lures.

For example, a fishing lure may be provided according to the present disclosure, which is made up of a soft plastic fishing bait molded from the composition described above; at least one hook attached to the soft plastic fishing bait, and at least one weight attached to the soft plastic fishing bait.

In some instances, the composition of the fishing bait may also include about 0.1 weight percent to about 5.0 weight percent of at least one attractant selected from the group consisting of glitter flakes, liquid colorant, powdered pigments, fish scent attractants, and mixtures thereof. More preferably, the composition may include from about 0.5 weight percent to about 2.0 weight percent of the at least one attractant.

Advantageously, the soft plastic fishing baits (and lures including such baits) and other flexible molded articles provided according to the present disclosure are biodegradable and do not include PVC or from phthalate-based compounds. Thus, such baits and lures biodegrade when lost in bodies of water and do not present the environmental hazards associated with materials such as PVC and phthalate-based compounds.

Alternatively, the plastisol composition may be used as a coating or may be incorporated into an ink formulation, as described below.

In addition to the plastisol composition itself, the present disclosure also provides an ink suitable for screen printing. In general, this ink comprises at least one pigment and a plastisol composition, as described above.

Thus, the screen-printing ink comprises at least one pigment. In some embodiments, the pigment is preferably an inorganic pigment. However, in other embodiments, the pigment is preferably an organic pigment. Examples of suitable pigments for the screen printing ink include Direct Blue 1, indigo dye, rhodamine, Disperse Red, cadmium green, carbon black, and titanium white. The amount of pigments in the ink is typically from about 1% to about 30% weight percent of the ink.

The screen-printing ink also includes the aforementioned plastisol. The amount of plastisol in the ink is typically from about 70 to about 99 weight percent of the ink.

Again, the plastisol composition, in turn, includes from about 1 to about 49 weight percent of at least one polyhydroxyalkanoate and from about 51 to about 99 weight percent of at least one plasticizer selected from the group consisting of epoxidized vegetable oils, citric acid esters, triglycerides, and mixtures thereof. Preferably, the plastisol composition comprises from about 1 to about 40 weight percent of the at least one polyhydroxyalkanoate and from about 60 to about 99 weight percent of the at least one plasticizer.

In certain embodiments, the plastisol composition of the ink more preferably includes from about 1 to about 10 weight percent of the at least one polyhydroxyalkanoate.

In certain preferred embodiments, the plastisol composition may comprise a combination of plasticizers. For instance, in some embodiments, the plastisol composition may comprise from about 60 to about 80 weight percent of at least one citric acid ester. This composition may also comprise from about 10 to about 35 weight percent of at least one triglyceride.

Further, a preferred citric acid ester may be triethyl citrate, and a preferred triglyceride may be triacetin. Thus, in certain embodiments, the plastisol composition may comprise a combination of these two plasticizers. For instance, the plastisol composition may comprise from about 60 to about 80 weight percent of triethyl citrate and from about 10 to about 35 weight percent of triacetin.

In certain embodiments, the ink preferably also includes at least one additive selected from the group consisting of fillers, rheology modifiers, stabilizing agents, and mixtures thereof.

In a further aspect, the present disclosure also provides a coated article. In accordance with one embodiment, the coating article includes at least a first surface and a coating applied over at least a portion of the first surface. The coating is applied by dipping the first surface in a plastisol composition.

In certain preferred embodiments, the article is preferably a hand tool, such as a wrench, pliers, screwdriver, file, rasp, chisel, or hammer. The coating is applied over the handle(s) of the tool to form a soft grip surface over the handle(s).

The above-described plastisol composition may be used for dip-coating the tool handles or other surfaces to be coated. As discussed above, this plastisol includes from about 1 to about 40 weight percent of at least one polyhydroxyalkanoate and from about 60 to about 99 weight percent of at least one plasticizer selected from the group consisting of epoxidized vegetable oils, citric acid esters, triglycerides, and mixtures thereof.

### Embodiments

The present disclosure is also further illustrated by the following embodiments: Embodiment 1. A composition for a plastisol comprising:
from about 1 to about 49 weight percent of at least one polyhydroxyalkanoate; and
from about 51 to about 99 weight percent of at least one plasticizer selected from the group consisting of epoxidized vegetable oils, citric acid esters, triglycerides, and mixtures thereof.

Embodiment 2. The composition of Embodiment 1, wherein the composition comprises from about 1 to about 40 weight percent of the at least one polyhydroxyalkanoate and from about 60 to about 99 weight percent of the at least one plasticizer.

Embodiment 3. The composition of Embodiment 1, wherein the composition comprises from about 1 to about 10 weight percent of the at least one polyhydroxyalkanoate.

Embodiment 4. The composition of any of the preceding Embodiments, wherein the at least one plasticizer consists of a citric acid ester.

Embodiment 5. The composition of any of the preceding Embodiments, wherein the at least one plasticizer consists of a triglyceride.

Embodiment 6. The composition of any of Embodiments 1-3, wherein the composition comprises from about 60 to about 80 weight percent of at least one citric acid ester.

Embodiment 7. The composition of Embodiment 6, wherein the composition further comprises from about 10 to about 35 weight percent of at least one triglyceride.

Embodiment 8. The composition of any of Embodiments 1-3, wherein the composition comprises from about 60 to about 80 weight percent of triethyl citrate.

Embodiment 10. The composition of Embodiment 8, wherein the composition further comprises from about 10 to about 35 weight percent of triacetin.

Embodiment 11. The composition of any of Embodiments 1-3, wherein the composition comprises at least one epoxidized vegetable oil selected from the group consisting of epoxidized soybean oil, epoxidized linseed oil, epoxidized castor oil, epoxidized coconut oil, epoxidized soybean oil, and mixtures thereof.

Embodiment 12. The composition of any of Embodiments 1-3, wherein the composition comprises epoxidized soybean oil.

Embodiment 13. The composition of any of the preceding Embodiments, wherein the composition further comprises from about 0.01 to about 0.5 weight percent of at least crosslinking agent selected from the group consisting of organic peroxides, epoxides, carbodiimides, oxazolines, and mixtures thereof.

Embodiment 14. The composition of any of the preceding Embodiments, wherein the composition further comprises from about 0.01 to about 1 weight percent of at least one nucleating agent selected from the group consisting of pentaerythritol, dipentaerythritol, boron nitride, and mixtures thereof.

Embodiment 15. The composition of any of the preceding Embodiments, wherein the composition further comprises from about 0.1 to about 20 weight percent of at least one biopolymer selected from the group consisting of polylactic acid, polybutylene succinate, polybutylene succinate adipate, polybutylene adipate terephthalate, phenylbenzimidazole sulfonic acid, and mixtures thereof.

Embodiment 16. The composition of any of the preceding Embodiments, wherein the at least one polyhydroxyalkanoate comprises a polyhydroxyalkanoate copolymer which includes from about 0.5 to about 25 mole percent monomer repeat units selected from the group consisting of 4-hydroxybutyrate, 3-hydroxyhexanoate, 3-hydroxyoctanoate, 3-hydroxydecanoate, and mixtures thereof.

Embodiment 17. The composition of any of the preceding Embodiments, wherein the at least one polyhydroxyalkanoate comprises one or more poly-3-hydroxybutyrate-co-3-hydroxyhexanoate (P3HB-co-P3HHx) copolymers, wherein each P3HB-co-P3HHx copolymer comprises from about 2 to about 15 mole percent monomer repeat units of 3-hydroxyhexanoate.

Embodiment 18. The composition of any of the preceding Embodiments, wherein the composition is free of phthalates.

Embodiment 19. The composition of any of the preceding Embodiments, further comprising from about 0.05 weight percent to about 1.0 weight percent of at least one nucleating agent selected from the group consisting of pentaerythritol, dipentaerythritol, boron nitride, poly(hydroxybutyrate), inositol, clays, sorbitol, and mixtures thereof.

Embodiment 20. The composition of any of the preceding Embodiments, further comprising from about 0.5 weight percent to about 20 weight percent of at least one filler selected from the group consisting of aragonite, clays, calcium carbonate, cellulose, nano-cellulose, talc, kaolinite, montmorillonite, bentonite, silica, chitin, starches, diatomaceous earth, titanium dioxide, nano clay, mica, and mixtures thereof.

Embodiment 21. The composition of any of the preceding Embodiments, further comprising from about 0.01 weight percent to about 1.0 weight percent of at least one rheology modifier selected from the group consisting of organic peroxides, carbodiimides, oxazolines, epoxides, and mixtures thereof.

Embodiment 22. The composition of any of the preceding Embodiments, further comprising from about 0.5 weight percent to about 20 weight percent of natural or synthetic fibers.

Embodiment 23. An ink for screen printing comprising:
at least one pigment; and
a plastisol composition according to any of the preceding Embodiments.

Embodiment 24. The ink of Embodiment 23, wherein the pigment is an inorganic pigment.

Embodiment 25. The ink of Embodiment 23, wherein the pigment is an organic pigment.

Embodiment 26. The ink of any of Embodiments 23-25, wherein the ink further comprises at least one additive selected from the group consisting of fillers, rheology modifiers, stabilizing agents, and mixtures thereof.

Embodiment 27. The ink of any of Embodiments 23-26, wherein the plastisol composition is present in the ink in an amount from about 70 to about 99 weight percent of the ink.

Embodiment 28. A coated article comprising at least a first surface and a coating applied over at least a portion of the first surface,
wherein the coating is applied by dip coating the first surface in a plastisol composition, wherein the plastisol composition comprises
from about 1 to about 49 weight percent of at least one polyhydroxyalkanoate; and
from about 51 to about 99 weight percent of at least one plasticizer selected from the group consisting of epoxidized vegetable oils, citric acid esters, triglycerides, and mixtures thereof.

Embodiment 29. The coated article of Embodiment 28, wherein the plastisol composition comprises from about 1 to about 40 weight percent of the at least one polyhydroxyalkanoate and from about 60 to about 99 weight percent of the at least one plasticizer.

Embodiment 30. The coated article of Embodiments 28 or 29, wherein the article is a hand tool, and the coating forms a hand grip.

Embodiment 31. A fishing lure comprising:
a soft plastic fishing bait molded from the composition of any of Embodiments 1-22;
at least one hook attached to the soft plastic fishing bait; and
at least one weight attached to the soft plastic fishing bait.

Embodiment 32. The fishing lure of Embodiment 31, wherein the composition further comprises from about 0.1 weight percent to about 5.0 weight percent of at least one attractant selected from the group consisting of glitter flakes, liquid colorant, powdered pigments, fish scent attractants, and mixtures thereof.

Embodiment 33. A process for making a molded article, comprising the steps of:
mixing at least one polyhydroxyalkanoate and at least one plasticizer selected from the group consisting of epoxidized vegetable oils, citric acid esters, triglycerides, and mixtures thereof to form a slurry comprising from about 1 to about 49 weight percent of the at least one polyhydroxyalkanoate and from about 51 to about 99 weight percent of the at least one plasticizer;
heating the slurry to a temperature of at least about 85° C. to form a molten mixture;
injecting the mixture into a mold;
cooling the mixture within the mold to form a solidified molded article; and
removing the molded article from the mold.

### EXAMPLES

The following non-limiting examples illustrate various additional aspects of the invention. Unless otherwise indicated, temperatures are in degrees Celsius, and percentages are by weight based on the dry weight of the formulation.

Example 1. In this example, a plastisol solution was prepared was prepared using a combination of two different forms of poly-3-hydroxybutyrate-co-3-hydroxyhexanoate (P3HB-co-P3HHx) copolymer, triethyl citrate, and triacetin. The composition is shown in Table 1 below. The components were initially combined via high shear mixing using a Silverson mixer. This mixture was allowed to sit overnight to fully plasticize the polyhydroxyalkanoate polymers. The mixture was heated to 110° C., transitioning from an opaque to a clear mixture. This clear mixture was then injected into a mold and cooled for 5 min to form a solid part.

Example 2. A plastisol solution was prepared in the same manner as in Example 1, except using the Example 2 composition shown in Table 1 below. The resulting molded part was a softer solid compared to Example 1.

Example 3. A plastisol solution was prepared in the same manner as in Example 1, except using the Example 3 composition shown in Table 1 below. The resulting molded part was a softer solid compared to both Examples 1 and 2.

TABLE 1

| Component | Example 1 | Example 2 | Example 3 |
|---|---|---|---|
| (P3HB-co-P3HHx) copolymer, | 8.0% | 5.0% | 4.0% |
| 94 mol % 3HB, 6 mol % 3HHx | | | |
| (P3HB-co-P3HHx) copolymer, | 12.0% | 5.0% | 4.0% |
| 88 mol % 3HB, 12 mol % 3HHx | | | |
| Triethyl citrate | 57.0% | 63.9% | 65.3% |
| Triacetin | 23.0% | 26.1% | 26.7% |

Example 4. A plastisol solution was prepared in the same manner as in Example 1, except using the Example 4 composition shown in Table 2 below. The plastisol solution was heated to 110° C., injected into a mold, and cooled for 5 min to form a solid part.

Example 5. A plastisol solution was prepared in the same manner as in Example 1, except using the Example 4 composition shown in Table 2 below. The plastisol solution was heated to 110° C., injected into a mold, and cooled for 5 min to form a solid part. The resulting molded part was a softer solid compared to Example 4.

Example 6. A plastisol solution was prepared in the same manner as in Example 1, except using the Example 4 composition shown in Table 2 below. The plastisol solution was heated to 110° C., injected into a mold, and cooled for 5 min to form a solid part. The resulting molded part was a softer solid compared to Examples 4 and 5.

TABLE 2

| Component | Example 4 | Example 5 | Example 6 |
|---|---|---|---|
| (P3HB-co-P3HHx) copolymer, | 12.0% | 10.0% | 8.0% |
| 98 mol % 3HB, 2 mol % 3HHx | | | |
| Triethyl citrate | 88.0% | 90.0% | 92.0% |

Example 7. A plastisol solution was prepared with the formulation from

Example 4. Dry pigment and glitter were added to the solution prior to heating at a concentration of 0.067 g of pigment/mL of plastisol. The colored solution was then heated to 110° C., injected into a mold, and cooled for 5 min to form a colored, solid part.

The foregoing description of preferred embodiments for this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application and to thereby enable one of ordinary skill in the art to utilize the disclosure in various embodiments and with various modifications as are suited to the particular use contemplated.

1. A composition for a plastisol comprising: from about 1 to about 49 weight percent of at least one polyhydroxyalkanoate; and from about 51 to about 99 weight percent of at least one plasticizer selected from the group consisting of epoxidized vegetable oils, citric acid esters, triglycerides, and mixtures thereof.

2. The composition of claim 1, wherein the composition comprises from about 1 to about 10 weight percent of the at least one polyhydroxyalkanoate.

3. The composition of claim 1, wherein the composition comprises from about 60 to about 80 weight percent of at least one citric acid ester.

4. The composition of claim 3, wherein the composition further comprises from about 10 to about 35 weight percent of at least one triglyceride.

5. The composition of claim 1, wherein the composition comprises from about 60 to about 80 weight percent of triethyl citrate.

6. The composition of claim 5, wherein the composition further comprises from about 10 to about 35 weight percent of triacetin.

7. The composition of claim 1, wherein the composition comprises at least one epoxidized vegetable oil selected from the group consisting of epoxidized soybean oil, epoxidized linseed oil, epoxidized castor oil, epoxidized coconut oil, epoxidized soybean oil, and mixtures thereof.

8. The composition of claim 1, wherein the composition comprises epoxidized soybean oil.

9. The composition of claim 1, wherein the composition further comprises from about 0.01 to about 0.5 weight percent of at least one crosslinking agent selected from the group consisting of organic peroxides, epoxides, carbodiimides, oxazolines, and mixtures thereof.

10. The composition of claim 1, wherein the composition further comprises from about 0.01 to about 1 weight percent of at least one nucleating agent selected from the group consisting of pentaerythritol, dipentaerythritol, boron nitride, and mixtures thereof, and/or wherein the composition further comprises from about 0.1 to about 20 weight percent of at least one biopolymer selected from the group consisting of polylactic acid, polybutylene succinate, polybutylene succinate adipate, polybutylene adipate terephthalate, phenylbenzimidazole sulfonic acid, and mixtures thereof.

11. (canceled)

12. The composition of claim 1, wherein the at least one polyhydroxyalkanoate comprises a polyhydroxyalkanoate copolymer which includes from about 0.5 to about 25 mole percent monomer repeat units selected from the group consisting of 4-hydroxybutyrate, 3-hydroxy hexanoate, 3-hydroxy octanoate, 3-hydroxydecanoate, and mixtures thereof, and/or wherein the at least one polyhydroxyalkanoate comprises one or more poly-3-hydroxybutyrate-co-3-hydroxyhexanoate (P3HB-co-P3HHx) copolymers, wherein each P3HB-co-P3HHx copolymer comprises from about 2 to about 15 mole percent monomer repeat units of 3-hydroxyhexanoate.

13. (canceled)

14. The composition of claim 1, wherein the composition is free of phthalates.

15. An ink for screen printing comprising:
at least one pigment; and
a plastisol composition comprising from about 1 to about 49 weight percent of at least one polyhydroxyalkanoate; and from about 51 to about 99 weight percent of at least one plasticizer selected from the group consisting of epoxidized vegetable oils, citric acid esters, triglycerides, and mixtures thereof.

16. The ink of claim 15, wherein the pigment is an inorganic pigment, or an organic pigment.

17. (canceled)

18. The ink of claim 15, wherein the ink further comprises at least one additive selected from the group consisting of fillers, rheology modifiers, stabilizing agents, and mixtures thereof.

19. The ink of claim 15, wherein the plastisol composition is present in the ink in an amount from about 70 to about 99 weight percent of the ink.

20. A coated article comprising at least a first surface and a coating applied over at least a portion of the first surface, wherein the coating is applied by dip coating the first surface in a plastisol composition, wherein the plastisol composition comprises from about 1 to about 49 weight percent of at least one polyhydroxyalkanoate; and from about 51 to about 99 weight percent of at least one plasticizer selected from the group consisting of epoxidized vegetable oils, citric acid esters, triglycerides, and mixtures thereof.

21. The coated article of claim 20, wherein the article is a hand tool, and the coating forms a hand grip.

22. A fishing lure comprising: a soft plastic fishing bait molded from a composition of comprising from about 1 to about 49 weight percent of at least one polyhydroxyalkanoate; and from about 51 to about 99 weight percent of at least one plasticizer selected from the group consisting of epoxidized vegetable oils, citric acid esters, triglycerides, and mixtures thereof; at least one hook attached to the soft plastic fishing bait; and at least one weight attached to the soft plastic fishing bait.

23. A process for making a molded article, comprising the steps of: mixing at least one polyhydroxyalkanoate and at least one plasticizer selected from the group consisting of epoxidized vegetable oils, citric acid esters, triglycerides, and mixtures thereof to form a slurry comprising from about 1 to about 49 weight percent of the at least one poly hydroxy alkanoate and from about 51 to about 99 weight percent of the at least one plasticizer; heating the slurry to a temperature of at least about 85° C. to form a molten mixture; injecting the mixture into a mold; cooling the mixture within the mold to form a solidified molded article; and removing the molded article from the mold.
